(19) United States
(12) Patent Application Publication
(10) Pub. No.: US 2026/0328629 A1
(43) Pub. Date: Oct. 22, 2026

(54) FLEXIBLE SENSING ELEMENT FOR ONLINE MONITORING OF LARGE STRAIN BASED ON PIEZORESISTIVE EFFECT, AND PREPARATION METHOD THEREOF

(71) Applicants: NATIONAL ENGINEERING RESEARCH CENTER OF HIGH-SPEED RAILWAY CONSTRUCTION TECHNOLOGY, Changsha (CN); CHINA RAILWAY GROUP LIMITED, Beijing (CN); CENTRAL SOUTH UNIVERSITY, Changsha (CN); CHINA RAILWAY TENTH BUREAU GROUP FIFTH ENGINEERING CO., LTD., Suzhou (CN); CENTRAL SOUTH UNIVERSITY OF FORESTRY AND TECHNOLOGY, Changsha (CN); CHINA CONSTRUCTION SECOND ENGINEERING BUREAU CO., LTD., Beijing (CN)

(72) Inventors: Peng LIU, Changsha (CN); Shuaifeng WANG, Changsha (CN); Zhiwu YU, Changsha (CN); Jun WU, Beijing (CN); Xiang CHENG, Changsha (CN); Lin CAO, Changsha (CN); Zhengtao CHEN, Changsha (CN); Qing LI, Changsha (CN); Ying CHEN, Changsha (CN); Xiaochun LIU, Changsha (CN); Rongzhen DONG, Changsha (CN); Lei CHEN, Suzhou (CN); Niu ZHANG, Suzhou (CN); Ziqing XU, Suzhou (CN); Guangqiang SHAO, Beijing (CN); Wei QIU, Beijing (CN); Guoqing WANG, Beijing (CN)

(73) Assignees: NATIONAL ENGINEERING RESEARCH CENTER OF HIGH-SPEED RAILWAY CONSTRUCTION TECHNOLOGY, Changsha (CN); CHINA RAILWAY GROUP LIMITED, Beijing (CN); CENTRAL SOUTH UNIVERSITY, Changsha (CN); CHINA RAILWAY TENTH BUREAU GROUP FIFTH ENGINEERING CO., LTD., Suzhou (CN); CENTRAL SOUTH UNIVERSITY OF FORESTRY AND TECHNOLOGY, Changsha (CN); CHINA CONSTRUCTION SECOND ENGINEERING BUREAU CO., LTD., Beijing (CN)

(21) Appl. No.: 19/373,668

(22) Filed: Oct. 29, 2025

(30) Foreign Application Priority Data
Apr. 22, 2025 (CN) 202510505932.X

(51) Int. Cl. G01L 1/18; C08J 3/205; C08J 5/06; C08J 5/12; C08K 3/04

(52) U.S. Cl. CPC G01L 1/18; C08J 3/2053; C08J 5/06; C08J 5/121; C08K 3/042; C08J 2375/04; C08J 2379/08; C08K 2201/001

(57) ABSTRACT

Provided are a flexible sensing element for online monitoring of large strain based on piezoresistive effect, and a preparation method thereof. The sensing element includes a cover layer, a sensor unit, and a composite polymer substrate layer that are sequentially stacked from top to bottom. Electrodes are attached to two ends of the sensor unit and are connected to an external signal processing device by lead wires. The sensor unit is obtained from a conductive filler/polymer coacervate by vacuum hot pressing and sintering, has a thickness of 5 μm to 1000 μm, and includes the following components in parts by mass: 10 parts to 100 parts of polymer and 1 part to 3 parts of conductive filler. The cover layer includes a thermoplastic polymer. The sensing element is prepared using the vacuum hot pressing and sintering process, greatly enhancing conductivity and sensitivity of the sensor unit.

### CROSS-REFERENCE TO RELATED APPLICATIONS

This application claims priority to the Chinese Patent Application No. 202510505932.X, filed on Apr. 22, 2025, the contents of which are hereby incorporated by reference.

### TECHNICAL FIELD

The present disclosure relates to a flexible sensing element, and specifically, to a flexible sensing element for online monitoring of large strain based on piezoresistive effect, and a preparation method thereof, and belongs to the field of flexible strain sensor technologies.

### BACKGROUND

Strain sensors, as one of the most critical technical devices for health monitoring of engineering structures, visually present changes in structural stress and strain through changes in resistance, for safety assessors to determine health status of the engineering structures, to prevent catastrophic damage. A resistance strain gauge, as the most widely used strain monitoring element at present, is obtained by preparing metal foil into a sensitive grid with a special pattern by photolithography, with high linearity and good durability. However, the resistance strain gauge, limited by elongation of the metal material, has a small measurement range and a low gauge factor, resulting in a limitation on health monitoring of structures prone to large strain, such as long-span bridges, dams, and tunnels. Therefore, it is particularly important to study and prepare a sensing element for monitoring large strain of a structure.

Flexible electronic elements, characterized by bendability, lightweight, and strong adaptability, not only offer significant advantages in innovative products such as wearable devices and robotics, but also have a wide application prospect in the field of health monitoring in civil engineering. Graphene and carbon nanotubes, as key materials for various future technological revolutions, exhibit high electron mobility and chemical stability due to their unique structures and highly ordered arrangement of carbon atoms, and therefore become primary sources of sensing materials for flexible electronic elements. Graphene or carbon nanotubes and a polymer with excellent flexibility are combined to prepare a flexible sensitive material with a stable conductive path and good resilience. This not only aligns with a piezoresistive effect of converting changes in structural stress and strain to changes in resistance, but also overcomes the shortcomings of an existing strain sensor, such as a small measurement range and a low gauge factor, making it possible to prepare a sensing element for large strain monitoring.

The Chinese patent (CN109990695A) discloses a flexible graphene-based piezoresistive sensor and a preparation method thereof. In this invention, by using a sandwich process, a graphene dispersion solution is applied on a flexible polymer substrate, and then a polymer liquid is applied uniformly on a graphene film, to form a graphene/polymer composite film. This method employs natural leveling during formation, which has a limited effect on stress concentration and air bubbles that are likely to occur in the film, making the bonding of material particles or molecules not tight enough, resulting in high porosity and poor elasticity of the formed graphene/polymer composite film. In addition, this invention adopts a three-layer successive pouring method, which fails to ensure film thickness and reproducibility. Moreover, the flexible sensor includes only one conductive path, that is, only one sensitive grid, resulting in poor responsiveness to small deformation, low resistance to external noise or interference, and large impacts on measurement results by local material defects or uneven stress. This hinders improvement in a linear relationship between resistance and strain, and increases a nonlinear error. Especially, there is a large error in high-precision measurement, consequently reducing stability and long-term reliability.

In view of this, it is necessary to provide a flexible sensing element for online monitoring of large strain based on piezoresistive effect and a preparation method thereof, which can substantially reduce a nonlinear error between resistance and strain while significantly enhancing the stability and reliability of the element.

### SUMMARY

One or more embodiments of the present disclosure provide a flexible sensing element for online monitoring of large strain based on piezoresistive effect, comprising a cover layer, a sensor unit, and a composite polymer substrate layer that are sequentially stacked from top to bottom, wherein: electrodes are attached to two ends of the sensor unit and are connected to an external signal processing device by lead wires; the sensor unit is obtained from a conductive filler/polymer coacervate by vacuum hot pressing and sintering, has a thickness of 5 μm to 1000 μm, and comprises the following components in parts by mass: 10 parts to 100 parts of polymer and 1 part to 3 parts of conductive filler; the cover layer comprises a thermoplastic polymer; and a method for preparing the flexible sensing element includes: mixing a polymer base material and a fiber reinforcing phase fully to obtain a mixture, coating the mixture on a mold, and drying the mixture to obtain the composite polymer substrate layer; placing the thermoplastic polymer on a press block, and performing vacuum hot pressing to obtain the cover layer; mixing the conductive filler and an organic solvent A fully, and adding the polymer, to obtain a conductive filler/polymer dispersion solution, adding an organic solvent B, performing full mixing, and sequentially performing separation, drying, and vacuum hot pressing and sintering, to obtain the sensor unit; and attaching the electrodes and the lead wires to the two ends of the sensor unit, attaching an upper portion of the sensor unit to the cover layer by vacuum forming, connecting a lower portion of the sensor unit to the composite polymer substrate layer by vacuum hot pressing, and performing cooling.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram of a structure of a flexible sensing element according to some embodiments of the present disclosure;

FIG. 2 is a graph of a relationship between a resistance change rate and strain of a flexible sensing element according to Example 1 of the present disclosure;

FIG. 3 is a graph of a relationship between a resistance change rate and strain of a flexible sensing element according to Example 2 of the present disclosure;

FIG. 4 is a graph of a relationship between a resistance change rate and strain of a flexible sensing element according to Example 3 of the present disclosure; and

FIG. 5 is a graph of a relationship between a resistance change rate and strain of a flexible sensing element according to Example 4 of the present disclosure.

### DETAILED DESCRIPTION

For easy understanding of the present disclosure, a more thorough description of the present disclosure is given below with reference to specific examples. However, the present disclosure may be implemented in many different forms and is not limited to the examples described in the present disclosure. On the contrary, these examples are provided for a more thorough understanding of the content disclosed in the present disclosure. Unless otherwise defined, all technical and scientific terms used herein have the same meaning as would normally be understood by a person skilled in the art of the present disclosure. In this specification, the terms used in the specification of the present disclosure are only for describing specific examples, and are not intended to limit the present disclosure.

To resolve the problem in the related art, a first objective of the present disclosure is to provide a flexible sensing element for online monitoring of large strain based on piezoresistive effect. Based on a synergistic effect between a polymer and a conductive filler, through the control of a ratio of the polymer to the conductive filler and the control of a thickness of the sensing element, the sensing element implements quantitative regulation of measurement precision and sensitivity, and greatly reduces a nonlinear error between resistance and strain, significantly improving stability and reliability of the element.

A second objective of the present disclosure is to provide a method for preparing the flexible sensing element for online monitoring of large strain based on piezoresistive effect. The method employs a vacuum hot pressing and sintering process, greatly enhancing conductivity and sensitivity of a sensor unit while ensuring bonding and homogeneity between a polymer matrix and a conductive filler. Further, the method greatly simplifies a formation process of the element, maintains a yield and stability of the element, and provides excellent structural stability and anti-interference for the element.

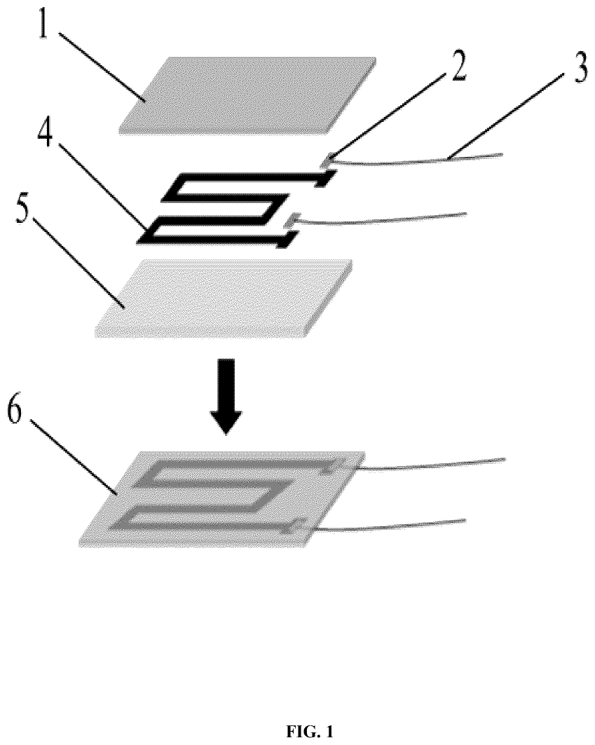

FIG. 1 is a diagram of a structure of a flexible sensing element according to some embodiments of the present disclosure.

In some embodiments, the present disclosure provides a flexible sensing element for online monitoring of large strain based on piezoresistive effect, including a cover layer 1, a sensor unit 4, and a composite polymer substrate layer 5 that are sequentially stacked from top to bottom, where electrodes 2 are attached to two ends of the sensor unit and are connected to an external signal processing device by lead wires 3; the sensor unit is obtained from a conductive filler/polymer coacervate by vacuum hot pressing and sintering, has a thickness of 5 μm to 1000 μm, and includes the following components in parts by mass: 10 parts to 100 parts of polymer and 1 part to 3 parts of conductive filler; and the cover layer 1 includes a thermoplastic polymer.

The flexible sensing element for online monitoring of large strain based on piezoresistive effect (hereinafter referred to as a flexible sensing element 6) is a type of strain sensor.

In some embodiments, the flexible sensing element 6 may be deployed within engineering structures such as bridges, dams, and tunnels. Based on the piezoresistive effect, the flexible sensing element 6 can sense mechanical strain within the structure and convert the mechanical strain into a readily detectable electrical resistance change rate. By monitoring the resistance change rate, deformation occurring inside the structure may be perceived.

In some embodiments, the flexible sensing element 6 includes the cover layer 1, the sensor unit 4, and the composite polymer substrate layer 5 that are stacked sequentially from top to bottom.

The cover layer 1 is an outermost protective structure of the flexible sensing element. The cover layer 1 serves to isolate the sensor unit 4 from external environmental interference, preventing malfunctions or performance degradation due to factors like humidity, dust accumulation, or physical wear, thereby maintaining the mechanical stability of the sensor unit 4. A material for the cover layer 1 need to possess flexibility, corrosion resistance, and insulation properties.

In some embodiments, the cover layer 1 is composed of the thermoplastic polymer.

The thermoplastic polymer may be repeatedly processed and shaped through temperature control. The thermoplastic polymer may exhibit a stable structure at room temperature, become fluid when heated to a critical temperature (a glass transition temperature T_g or a melting temperature T_m), and re-solidify into a stable structure upon cooling. The shape of a thermoplastic polymer may be adjusted repeatedly via the “heating-forming-cooling-solidifying” process. The type of thermoplastic polymer may be selected based on the application scenario. For more details on the type of thermoplastic polymer, refer to the relevant description below.

In some embodiments, if the cover layer is too thick, it may affect the sensor's sensitivity, whereas if it is too thin, it may compromise its protective effect. The thickness of the cover layer 1 can be flexibly adjusted according to the application scenario.

The electrode 2 is a component within the flexible sensing element used for a conducting electrical signal. Two ends of the electrode 2 are connected to the sensor unit 4 and the lead wires 3, respectively. A material of the electrodes 2 need to possess high conductivity, appropriate flexibility, and good adhesion to the sensor unit 4.

In some embodiments, the electrodes 2 may be made from one or a combination of: a metal foil, a graphene film, a carbon nanotube film, or a conductive polymer film (e.g., PEDOT:PSS). The metal foil includes, but is not limited to, an aluminum foil, a nickel foil, a silver foil, and a gold foil. The conductive polymer film includes, but is not limited to, polyaniline (PANI) and polypyrrole (PPy).

In some embodiments, each of the electrodes 2 is a copper foil.

In some embodiments, using the copper foil as the electrode 2 offers excellent conductivity, effectively reducing contact resistance and ensuring efficient transmission of the electrical signal from the sensor unit 4. Furthermore, the copper foil possesses good ductility, allowing it to accommodate the dynamic deformation requirements of the flexible sensing element, preventing electrode fracture under severe strain, and significantly extending the service life of the electrode 2.

The lead wire 3 is a conductive line connecting the electrode 2 to the external signal processing device. The lead wire 3 is configured to transmit the electrical signal generated by the sensor unit 4 to the external signal processing device via the electrode 2.

In some embodiments, the lead wire 3 may be a metal wire, such as a copper wire, an aluminum wire, a silver wire, a gold wire, a nickel wire, or a tin-plated copper wire. Alternatively, the lead wire 3 may be a flexible printed circuit, a carbon nanotube fiber, a conductive polymer fiber, etc.

In some embodiments, the lead wire 3 and the electrode 2 may be connected in various ways, such as conductive adhesive bonding, riveting, or snap-fit connection.

In some embodiments, the lead wire 3 and the electrode 2 are connected by welding.

In some embodiments, connecting the lead wire 3 and the electrode 2 by welding enhances the mechanical strength at the connection point and reduces contact resistance. This ensures that the connection is less prone to loosening or oxidation during long-term use, significantly improving the long-term operational reliability of the flexible sensing element 6.

The external signal processing device is equipment for detecting the resistance change rate. The external signal processing device includes, but is not limited to, a digital multimeter, a Wheatstone bridge, and an impedance analyzer.

The sensor unit 4 is a core component for sensing stress and strain. The sensor unit 4 exhibits the piezoresistive effect. When the flexible sensing element 6 is subjected to mechanical stress, the sensor unit 4 within the flexible sensing element 6 bends, causing its electrical resistance to change accordingly. The external signal processing device may detect a resistance change rate of the sensor unit 4, thereby inferring the stress and strain in the engineering structure, enabling health monitoring of structures like bridges, dams, and tunnels.

In some embodiments, the sensor unit 4 is obtained from a conductive filler/polymer coacervate by vacuum hot pressing and sintering.

The conductive filler/polymer coacervate is a homogeneous mixture formed by uniformly dispersing a conductive filler within a polymer matrix.

Vacuum hot pressing and sintering (hereinafter referred to as vacuum hot pressing) is a material densification process, which may be performed using equipment such as a vacuum hot pressing sintering furnace. Vacuum hot pressing utilizes the synergistic effects of vacuum, high temperature, and high pressure to fully combine raw materials and eliminate internal pores, resulting in a product with high density and good structural uniformity, significantly enhancing the material's densification and structural homogeneity.

The specific steps and parameters of vacuum hot pressing may be flexibly adjusted according to the application scenario. For more details on vacuum hot pressing, refer to the relevant description below.

In some embodiments, the conductive filler/polymer coacervate includes a polymer and a conductive filler.

The conductive filler is a functional material possessing electrical conductivity. The conductive filler is compounded with the polymer to enhance the composite material's conductivity.

The types and ratios of the polymer and conductive filler may be flexibly adjusted based on the application scenario.

In some embodiments, the polymer is at least one of thermoplastic polyurethane, thermoplastic polyethylene glycol terephthalate, styrene-butadiene-styrene, thermoplastic polyamide, thermoplastic polyolefin, thermoplastic rubber, thermoplastic polyether, styrene-isoprene-styrene, polypropylene, polyvinyl chloride, polycarbonate, and polyethylene; and the conductive filler is at least one of graphite, graphene, carbon black, carbon nanotubes, copper powder, silver powder, gold powder, aluminum powder, and nickel powder.

The polymer used in the present disclosure has high resilience and has a fixed glass transition temperature, and is suitable for a hot pressing preparation process and meets a large tensile range required by a flexible sensor material. In addition, after the polymer and the conductive material are mixed uniformly, specific conductivity can be further provided, ensuring the conversion from a pressure signal to an electrical signal that can be captured.

In some embodiments, a count of layers of the graphene is 3 to 200, a sheet diameter distribution is 0.5 μm to 500 μm, and a proportion of a sheet diameter of 0.5 μm to 50 μm is ≥80%, the carbon nanotubes are multi-walled carbon nanotubes, with an outer diameter of 1 nm to 100 nm, a length of 1 μm to 50 μm, and a hydroxyl content ≤5 wt %.

In some embodiments, the count of layers of the graphene may also be: 3, 10, 20, 50, 100, 150, 175, or 200.

In some embodiments, the count of layers of the graphene may also be in a range of: 3-50, 50-100, 100-150, 50-175, 100-200, 3-150, 50-175, 20-50, 50-150, or 150-200.

In some embodiments, the sheet diameter distribution of the graphene may also be in a range of: 0.5 μm-100 μm, 0.5 μm-200 μm, 0.5 μm-300 μm, or 0.5 μm-400 μm .

In some embodiments, the proportion of the sheet diameter of 0.5 μm to 50 μm is ≥80%.

In some embodiments, the proportion of the sheet diameter of 0.5 μm to 50 μm may be: 80%, 82%, 85%, 88%, 90%, 92%, 95%, 98%, or 99%.

In some embodiments, the proportion of the sheet diameter of 0.5 μm to 50 μm may be also be: ≥85%, ≥90%, ≥95%, ≥98%, or ≥99%.

In some embodiments, the sheet diameter of the graphene may fall within the range of 0.5 μm-50 μm.

In some embodiments, the sheet diameter of the graphene may also be: 0.5 μm, 1 μm, 2 μm, 5 μm, 10 μm, 15 μm, 20 μm, 30 μm, 40 μm, or 50 μm.

In some embodiments, the sheet diameter distribution of the graphene may also be in a range of: 0.5 μm-5 μm, 10 μm-15 μm, 25 μm-30 μm, 40 μm-45 μm, 0.5 μm-10 μm, 20 μm-30 μm, 30 μm-40 μm, 0.5 μm-15 μm, 15 μm-30 μm, 0.5 μm-20 μm, or 25 μm-50 μm.

In some embodiments, the carbon nanotubes are multi-walled carbon nanotubes. The multi-walled carbon nanotubes are tubular carbon nanotubes formed by coaxial nesting of multiple layers of graphene.

In some embodiments, the multi-walled carbon nanotubes have an outer diameter of 1 nm-100 nm and a length of 1 μm-50 μm.

In some embodiments, the outer diameter of the multi-walled carbon nanotubes may also be: 1 nm, 5 nm, 10 nm, 20 nm, 30 nm, 40 nm, 50 nm, 60 nm, 70 nm, 80 nm, 90 nm, or 100 nm; and the length of the multi-walled carbon nanotubes may also be: 1 μm, 5 μm, 10 μm, 15 μm, 20 μm, 25 μm, 30 μm, 35 μm, 40 μm, 45 μm, or 50 μm.

In some embodiments, the outer diameter of the multi-walled carbon nanotubes may also be in a range of: 1 nm-10 nm, 10 nm-20 nm, 20 nm-30 nm, 30 nm-40 nm, 40 nm-50 nm, 50 nm-60 nm, 60 nm-70 nm, 70 nm-80 nm, 80 nm-90 nm, 90 nm-100 nm, 1 nm-30 nm, 30 nm-60 nm, 60 nm-100 nm, 1 nm-50 nm, 50 nm-100 nm, 1 nm-70 nm, 30 nm-90 nm, or 50 nm-80 nm; and the length of the multi-walled carbon nanotubes may also be in a range of: 1 μm-10 μm, 10 μm-20 μm, 20 μm-30 μm, 30 μm-40 μm, 40 μm-50 μm, 1 μm-20 μm, 20 μm-40 μm, 1 μm-30 μm, 30 μm-50 μm, 1 μm-40 μm, 20 μm-50 μm, 1 μm-25 μm, 25 μm-50 μm, 1 μm-15 μm, 15 μm-30 μm, or 30 μm-45 μm.

In some embodiments, the hydroxyl content of the multi-walled carbon nanotubes is ≤5 wt %.

In some embodiments, the hydroxyl content of the multi-walled carbon nanotubes may also be: 4.5 wt %, 4.0 wt %, 3.5 wt %, 3.0 wt %, 2.5 wt %, 2.0 wt %, 1.5 wt %, 1.0 wt %, or 0.5 wt %.

In some embodiments, the hydroxyl content of the multi-walled carbon nanotubes may also be: ≤4.5 wt %, ≤4.0 wt %, ≤3.5 wt %, ≤3.0 wt %, ≤2.5 wt %, ≤2.0 wt %, ≤1.5 wt %, ≤1.0 wt %, or ≤0.5 wt %.

In some embodiments, the multi-walled carbon nanotubes may contain no hydroxyl groups, i.e., the hydroxyl content is 0 wt %.

In some embodiments, by configuring the graphene with 3 to 200 layers, the sheet diameter distribution of 0.5 μm to 500 μm, and the proportion of the sheet diameter of 0.5 μm to 50 μm being ≥80%; and using multi-walled carbon nanotubes with the outer diameter of 1 nm to 100 nm, the length of 1 μm to 50 μm, and the hydroxyl content≤5 wt %, the dimensional uniformity and electrical conductivity of the conductive filler can be ensured. Compared to single-walled carbon nanotubes, the multi-walled carbon nanotubes have a more mature preparation process and lower cost. While ensuring conductive performance, this configuration can effectively reduce the cost of the conductive filler.

In some embodiments, the mass parts composition of the polymer and the conductive filler is: 10 to 100 parts of polymer and 1 to 3 parts of conductive filler.

In some embodiments, the mass parts of the polymer may also be: 10 parts, 20 parts, 30 parts, 40 parts, 50 parts, 60 parts, 70 parts, 80 parts, 90 parts, or 100 parts; and the mass parts of the conductive filler may also be: 1 part, 2 parts, or 3 parts.

The mass parts of the polymer may also be in a range of: 10-50 parts, 30-70 parts, 50-90 parts, 10-70 parts, 20-80 parts, 30-90 parts, 40-100 parts, 10-80 parts, 20-90 parts, 30-100 parts, 10-90 parts, or 20-100 parts; and the mass parts of the conductive filler may also be in a range of: 1-2 parts, 1.5-2.5 parts, 2-3 parts, 1-2.5 parts, or 1.5-3 parts.

In some embodiments, the thickness of the sensor unit 4 is in a range of 5 μm 1000 μm.

In some embodiments, the thickness of the sensor unit 4 may also be: 5 μm, 10 μm, 20 μm, 40 μm, 100 μm, 200 μm, 300 μm, 500 μm, 700 μm, 900 μm, or 1000 μm.

In some embodiments, the thickness of the sensor unit 4 may also be in a range of: 5 μm-10 μm, 10 μm-20 μm, 20 μm-40 μm, 40 μm-100 μm, 100 μm-200 μm, 200 μm-300 μm, 300 μm-500 μm, 500 μm-700 μm, 700 μm-900 μm, 900 μm-1000 μm, 5 μm-40 μm, 20 μm-100 μm, or 40 μm-200 μm.

In the sensor unit 4 provided in the present disclosure, the thickness of the sensor unit 4 and a ratio between the polymer and the conductive filler in the sensor unit 4 need to be strictly controlled. The thickness of the sensor unit 4 is positively correlated with sensitivity. An excessively large thickness of the sensor unit leads to a large loss of a structure during strain transfer, obtaining inaccurate measurement results. An addition amount of the conductive filler affects conductivity of the sensor unit. An excessively large addition amount of the conductive filler increases a nonlinear error of the sensing element, reducing stability. An excessively small addition amount of the conductive filler leads to an excessively low response rate of the sensor unit, which fails to maintain a timely response.

The composite polymer substrate layer 5 (hereinafter referred to as the substrate layer 5) is a supporting structure of the flexible sensing element. The substrate layer 5 serves to carry functional layers such as the electrodes 2 and the sensor unit 4, and imparts bendable characteristics to the flexible sensing element 6.

In some embodiments, to ensure the service life of the flexible sensing element 6, the substrate layer 5 should possess good flexibility and wear resistance. The material and thickness of the substrate layer may be adjusted according to the application scenario to accommodate different deformation requirements.

In some embodiments, the composite polymer substrate layer 5 includes a polymer base material and a fiber reinforcing phase in a mass ratio of 1:(0.02-5); the polymer base material is at least one of polyimide or polyester; and the fiber reinforcing phase is at least one of aramid fibers, carbon fibers, carbon nanotubes, and graphene.

The polymer base material is a base material of the substrate layer 5. The polymer base material provides flexible support and ensures the structural stability of the substrate layer 5.

In some embodiments, the polymer base material includes at least one of polyimide and polyester. For example, the polyimide includes polybismaleimide, thermoplastic polyimide, polyetherimide, polyamide-imide, etc.; and the polyester includes polyethylene terephthalate, polybutylene terephthalate, polyethylene naphthalate, polylactic acid, etc.

The fiber reinforcing phase is a functional material that enhances the mechanical properties of the substrate layer 5. The fiber reinforcing phase improves the tensile strength, flexural modulus, and fatigue resistance of the substrate layer 5. The fiber reinforcing phase may include at least one of aramid fibers, carbon fibers, carbon nanotubes, and graphene.

In some embodiments, the fiber reinforcing phase is surface-treated.

Surface treatment is a pre-treatment process that modifies a surface of the fiber reinforcing phase, which employs physical or chemical means to improve the interfacial compatibility between the fiber reinforcing phase and the polymer base material, enhance the interfacial bonding strength, and optimize the mechanical properties and uniformity of the substrate layer 5.

In some embodiments, because the surface of the fiber reinforcing phase may be overly smooth and contain residual impurities, leading to poor interfacial wetting, delamination, or debonding, physical manners such as plasma etching or mechanical abrasion may be used. These manners remove impurities from the surface of the fiber reinforcing phase and increase its surface roughness, thereby improving its wettability.

In some embodiments, since the polymer base material contains a large number of polar groups (such as imide groups, ester groups, hydroxyl groups, etc.) and has high surface energy and polarity, chemical manners like oxidation treatment or coupling agent modification may be employed to enhance the interfacial wettability of the fiber reinforcing phase. These manners introduce numerous functional groups (e.g., carboxyl, hydroxyl) onto the surface of the fiber reinforcing phase, increasing its polarity and improving the interfacial bonding strength with the fiber reinforcing phase.

In some embodiments, by subjecting the fiber reinforcing phase to surface treatment, active functional groups may be introduced or the surface roughness may be increased on its surface. This enhances the strength of chemical adsorption or mechanical interlocking between the polymer base material and the fiber reinforcing phase, effectively preventing the formation of microcracks due to interfacial separation when the substrate layer 5 is under stress and deformation.

In some embodiments, the mass ratio of the polymer base material to the fiber reinforcing phase is 1:(0.02-5).

In some embodiments, the mass ratio of the polymer base material to the fiber reinforcing phase is: 1:0.02, 1:0.1, 1:0.5, 1:1, 1:2, 1:3, 1:4, or 1:5.

In some embodiments, the mass ratio of the polymer base material to the fiber reinforcing phase is in a range of: 1:(0.02-2), 1:(0.1-3), 1:(0.5-4), 1:(1-5), 1:(0.02-1), 1:(0.1-2), 1:(0.5-3), 1:(1-4), 1:(2-4), or 1:(3-5).

In some embodiments, the substrate layer 5, including the polymer base material and the fiber reinforcing phase, fully utilizes the high-temperature resistance and mechanical strength of polyimide, as well as the flexibility and processability of polyester, endowing the substrate layer 5 with good wear resistance and service life. By defining the mass ratio of the polymer base material to the fiber reinforcing phase as 1:(0.02-5), a balance between the flexibility and mechanical strength of the substrate layer 5 is achieved. This ensures that the substrate layer 5 possesses a certain deformation capability while effectively buffering external stress impacts and protecting the internal sensor unit 4.

In some embodiments, a thickness of the cover layer 1 and the substrate layer 5, as well as the porosity of the sensor unit 4 may be flexibly adjusted based on practical requirements.

In some embodiments, the thickness of the cover layer 1 and the substrate layer 5 is 5 μm to 500 μm ; and the porosity of the sensor unit is 0.5% to 30%.

In some embodiments, the thickness of the cover layer 1 and the substrate layer 5 is: 5 μm, 50 μm, 100 μm, 150 μm, 200 μm, 250 μm, 300 μm, 350 μm, 400 μm, 450 μm, or 500 μm.

In some embodiments, the thickness of the cover layer 1 and the substrate layer 5 is in a range of: 5 μm-100 μm, 50 μm-200 μm, 100 μm-300 μm, 200 μm-400 μm, 300 μm-500 μm, 5 μm-200 μm, 100 μm-400 μm, 200 μm-500 μm, 5 μm-300 μm, 150 μm-450 μm, 5 μm-400 μm, or 250 μm-500 μm.

In some embodiments, the porosity of the sensor unit 4 is: 0.5%, 5%, 10%, 15%, 20%, 25%, or 30%.

In some embodiments, the porosity of the sensor unit 4 is in a range of: 0.5%-10%, 5%-15%, 10%-20%, 15%-25%, 20%-30%, 0.5%-15%, 5%-20%, 10%-25%, 15%-30%, 0.5%-20%, 8%-25%, or 12%-30%.

In some embodiments, the porosity is a measurement indicator of the density of the sensor unit. If the porosity is excessively low, the density inside the unit is excessively high, leading to a decrease in a deformation capability of the sensor unit, and consequently reducing sensitivity to pressure changes and affecting linearity and precision of an output signal. If the porosity is excessively high, the flexible sensing element 6 undergoes a sudden change during deformation under force, affecting sensitivity of the flexible sensing element. The present disclosure ensures uniformity of the sensor unit 4 across different production batches by strictly controlling its porosity.

In some embodiments, a routing pattern of the sensor unit 4 may be determined based on practical requirements. For example, the sensor unit 4 may employ straight-line routing. As another example, the sensor unit 4 may employ curved routing, among other patterns.

In some embodiments, the sensor unit 4 adopts a serpentine routing pattern. As shown in FIG. 1, the sensor unit 4 in FIG. 1 utilizes the serpentine routing pattern, which forms multiple parallel, spaced sub-paths through periodic folding. This configuration can extend the effective length of the sensor unit 4 within a limited space. The count of folds, as well as the length and spacing of the sub-paths in the serpentine routing may be determined based on prior experience and practical requirements.

Compared with conventional sensors with straight-line sensor units, the flexible sensing element 6 provided in the present disclosure adopts a serpentine routing pattern for the sensor unit 4, which can provide more resistance changes under strain, effectively improving sensitivity and measurement precision. In addition, the serpentine routing pattern can effectively distribute strain signals, reducing impacts of local material defects or uneven stress on measurement results, thereby improving stability and long-term reliability. Moreover, the serpentine routing pattern further help improve a linear relationship between resistance and strain, providing a more linear output and reducing a nonlinear error, thereby effectively resolving the problems in the related art of a large nonlinear error and low stability of the sensing element.

In some embodiments, the present disclosure further provides a method for preparing the flexible sensing element 6, including following operations.

S1, mixing a polymer base material and a fiber reinforcing phase fully to obtain a mixture, coating the mixture on a mold, and drying the mixture to obtain the substrate layer 5; placing a thermoplastic polymer on a press block, and performing vacuum hot pressing to obtain the cover layer 1.

In some embodiments, mechanical stirring and ultrasonic dispersion may be employed to achieve fully mixing of the raw materials. For example, mechanical stirring may be performed using equipment such as magnetic stirrers or planetary mixers, while ultrasonic dispersion may be carried out using devices like ultrasonic dispersers or ultrasonic vibrators. Specific operating parameters for mechanical stirring and ultrasonic dispersion may be set based on actual requirements.

In some embodiments, the coating manner includes using squeegee coating, cast casting, or spray coating to uniformly apply the mixed polymer base material and fiber reinforcement phase onto a surface of the mold, ensuring consistent coating thickness.

In some embodiments, the drying process may involve air drying, oven heating, or vacuum drying to remove solvents or moisture from the system, promote material curing, and avoid cracking or deformation of the substrate layer 5 caused by insufficient drying.

In some embodiments, the placing the thermoplastic polymer on a press block, and performing vacuum hot pressing to obtain the cover layer includes: placing the thermoplastic polymer on the press block, placing spacers on two sides of the press block to control a thickness of the cover layer, and performing heating and pressing under vacuum to obtain the cover layer.

In some embodiments, during vacuum hot pressing, the thermoplastic polymer may be placed in a central area between the press block and a copper sheet, with spacers positioned in a peripheral area between the press block and the copper sheet. Under vacuum and heating conditions, a pressure is applied to the press block, causing the molten polymer to spread and form the cover layer 1 with a thickness defined by the spacers. The spacers may also act as stops to define the shape of the cover layer 1. For example, when the spacers are arranged to form a triangle, the resulting cover layer 1 after vacuum hot pressing may also be triangular. Furthermore, the spacers determine a thickness of the hot-pressed product. By selecting spacers of different thicknesses, the thickness of the final hot-pressed product can be flexibly adjusted.

In some embodiments, by placing the thermoplastic polymer on the press block, positioning the spacers on two sides to control the thickness of the cover layer, and performing heating and pressing in a vacuum environment to obtain the cover layer, the high flatness of the press block and copper sheet can be utilized to ensure uniform thickness of the cover layer 1. Additionally, by using spacers of different thicknesses and altering their arrangement, the dimension and thickness of the cover layer 1 can be flexibly adjusted.

S2, mixing the conductive filler and an organic solvent A fully, and adding the polymer, to obtain a conductive filler/polymer dispersion solution, adding an organic solvent B, performing full mixing, and sequentially performing separation, drying, and vacuum hot pressing and sintering, to obtain the sensor unit 4.

In some embodiments, a process of the full mixing includes: mechanical stirring at a rotational speed of 500 r/min to 6000 r/min for 0.1 h to 6 h, and then ultrasonic dispersion for 0.1 h to 6 h.

In some embodiments, the rotational speed for mechanical stirring is: 500 r/min, 1000 r/min, 1500 r/min, 2000 r/min, 2500 r/min, 3000 r/min, 3500 r/min, 4000 r/min, 4500 r/min, 5000 r/min, 5500 r/min, or 6000 r/min.

In some embodiments, the rotational speed for mechanical stirring is in a range of: 500 r/min-1500 r/min, 1000 r/min-2500 r/min, 2000 r/min-4000 r/min, 3000 r/min-5000 r/min, 4000 r/min-6000 r/min, or 500 r/min-2000 r/min.

In some embodiments, duration of mechanical stirring is: 0.1 h, 0.5 h, 1 h, 1.5 h, 2 h, 2.5 h, 3 h, 3.5 h, 4 h, 4.5 h, 5 h, 5.5 h, or 6 h.

In some embodiments, the duration of mechanical stirring is in a range of: 0.1 h-1 h, 0.5 h-2 h, 1 h-3 h, 2 h-4 h, 3 h-5 h, 4 h-6 h, 0.1 h-2 h, 0.5 h-3 h, 1 h-4 h, 2 h-5 h, 3 h-6 h, 0.1 h-3 h, 1 h-5 h, or 2 h-6 h.

In some embodiments, duration of ultrasonic dispersion is: 0.1 h, 0.5 h, 1 h, 1.5 h, 2 h, 2.5 h, 3 h, 3.5 h, 4 h, 4.5 h, 5 h, 5.5 h, or 6 h.

In some embodiments, the duration of ultrasonic dispersion is in a range of: 0.1 h-1 h, 0.5 h-2 h, 1 h-3 h, 2 h-4 h, 3 h-5 h, 4 h-6 h, 0.1 h-2 h, 0.5 h-3 h, 1 h-4 h, 2 h-5 h, 3 h-6 h, 0.1 h-3 h, 1 h-5 h, or 2 h-6 h.

In some embodiments, a concentration of the conductive filler/polymer dispersion solution is 0.1 mg/mL to 50 mg/mL.

In some embodiments, the concentration of the conductive filler/polymer dispersion solution is: 0.1 mg/ml, 0.5 mg/ml, 1 mg/ml, 5 mg/ml, 10 mg/ml, 20 mg/ml, 30 mg/ml, 40 mg/ml, or 50 mg/ml.

In some embodiments, the concentration of the conductive filler/polymer dispersion solution is in a range of: 5 mg/ml-20 mg/ml, 10 mg/ml-30 mg/ml, 20 mg/ml-40 mg/ml, 30 mg/ml-50 mg/ml, 1 mg/ml-20 mg/ml, 5 mg/ml-30 mg/ml, 10 mg/ml-40 mg/ml, or 20 mg/ml-50 mg/ml.

In some embodiments, by performing mechanical stirring at a rotational speed of 500 r/min to 6000 r/min for 0.1 h to 6 h, followed by ultrasonic dispersion for 0.1 h to 6 h to achieve fully mixing, the raw materials can be adequately blended, preventing phenomena such as stratification caused by uneven mixing. Furthermore, by setting the concentration of the conductive filler/polymer dispersion solution within the range of 0.1 mg/ml to 50 mg/ml, an appropriate concentration of the conductive filler is ensured, thereby avoiding issues such as agglomeration at excessively high concentrations or reduced conductivity at excessively low concentrations.

The organic solvent A is a good solvent capable of adequately dissolving the polymer. The polymer may be uniformly dispersed in the organic solvent A, ensuring the formation of the conductive filler/polymer dispersion solution with good homogeneity from the conductive filler, the polymer, and the organic solvent A.

The organic solvent B is a poor solvent with lower dissolving power compared to the organic solvent A. By adding the organic solvent B to the conductive filler/polymer dispersion solution, the solubility of the polymer is reduced, promoting the co-precipitation of the polymer and conductive filler to form a conductive filler/polymer coacervate.

In some embodiments, the organic solvent A and the organic solvent B may be determined based on practical requirements.

In some embodiments, the organic solvent A includes at least one of tetrahydrofuran, N-methylpyrrolidone, N, N-dimethylformamide, ethyl acetate, butyl ester, acetone, isopropanol, benzene, toluene, xylene, and dichloromethane; and

In some embodiments, the organic solvent B includes at least one of methanol, ethanol, isopropanol, n-hexane, cyclohexane, n-heptane, ethylene, propylene, chloroform, vinyl chloride, and styrene.

To resolve the problem that the polymer is hardly mixed uniformly with the conductive filler due to a large viscosity coefficient of the polymer, in the present disclosure, based on the principle of coacervation of polymers, the polymer and the conductive filler are fully dispersed in the organic solvent A, and stirred to fully mix the polymer and the conductive filler, and then the organic solvent B is added to promote the co-precipitation of the polymer and conductive filler, the remaining organic solvents are then volatilized and removed, to obtain the uniformly mixed conductive filler/polymer coacervate. The mixing manner of the present disclosure enables uniform dispersion at the nanoscale, resulting in the conductive filler/polymer coacervate that are resistant to local enrichment or sedimentation.

In some embodiments, after adding the organic solvent B to the conductive filler/polymer dispersion solution and fully mixing, the polymer and conductive filler in the conductive filler/polymer dispersion solution co-precipitate. The precipitate is separated from the mixed solvents and thoroughly dried to obtain the conductive filler/polymer coacervate. Vacuum hot pressing and sintering of the conductive filler/polymer coacervate yields the sensor unit 4. For more descriptions of vacuum hot pressing, refer to the process of performing vacuum hot pressing to obtain the cover layer 1 and related descriptions in S1.

In some embodiments, the drying is vacuum drying under a following condition: a temperature of 50 ° C. to 100 ° C. and duration of 3 h to 12 h; and a condition of the vacuum hot pressing and sintering includes: heating at 5 ° C./min to 40 ° C./min under a pressure of 0.5 MPa to 5 MPa from room temperature to 100 ° C. to 500 ° C., and heat preservation for 0.5 h to 6 h, with a vacuum degree less than 100 Pa.

The drying is vacuum drying, with a following condition: a temperature of 50 ° C. to 100 ° C. and duration of 3 h to 12 h.

In some embodiments, the temperature of the vacuum drying is 50 ° C. to 100 ° C., and the duration is 3 h to 12 h.

In some embodiments, the temperature of the vacuum drying is: 50 ° C., 60 ° C., 70 ° C., 80 ° C., 90 ° C., or 100 ° C.; and the duration is: 3 h, 4 h, 5 h, 6 h, 7 h, 8 h, 9 h, 10 h, 11 h, or 12 h.

In some embodiments, the temperature of the vacuum drying is in a range of: 50 ° C.-60 ° C., 50 ° C.-80 ° C., 60 ° C.-70 ° C., 60 ° C.-100 ° C., 70 ° C.-90 ° C., 80 ° C.-100 ° C., or 90 ° C.-100 ° C.; and the duration is in a range of: 3 h-5 h, 3 h-9 h, 5 h-7 h, 5 h-12 h, 7 h-11 h, 9 h-12 h, or 10 h-12 h.

In some embodiments, the pressure for vacuum hot pressing and sintering is 0.5 MPa to 5 MPa.

In some embodiments, the pressure for vacuum hot pressing and sintering is: 0.5 MPa, 1 MPa, 1.5 MPa, 2 MPa, 2.5 MPa, 3 MPa, 3.5 MPa, 4 MPa, 4.5 MPa, or 5 MPa.

In some embodiments, the pressure for vacuum hot pressing and sintering is in a range of: 0.5 MPa-2 MPa, 1 MPa-3 MPa, 2 MPa-4 MPa, 3 MPa-5 MPa, 0.5 MPa-3 MPa, 1 MPa-4 MPa, 2 MPa-5 MPa, 0.5 MPa-4 MPa, 1 MPa-5 MPa, 0.5 MPa-2.5 MPa, 1.5 MPa-3.5 MPa, or 2.5 MPa-4.5 MPa.

In some embodiments, a heating rate for vacuum hot pressing and sintering is 5 ° C./min to 40 ° C./min.

In some embodiments, the heating rate for vacuum hot pressing and sintering is 5 ° C./min to 40 ° C./min.

In some embodiments, the heating rate for vacuum hot pressing and sintering is: 5 ° C./min, 10 ° C./min, 15 ° C./min, 20 ° C./min, 25 ° C./min, 30 ° C./min, 35 ° C./min, or 40 ° C./min.

In some embodiments, the heating rate for vacuum hot pressing and sintering is in a range of: 5 ° C./min-15 ° C./min, 10 ° C./min-20 ° C./min, 15 ° C./min-25 ° C./min, 20 ° C./min-30 ° C./min, 25 ° C./min-35 ° C./min, 30 ° C./min-40 ° C./min, 5 ° C./min-20 ° C./min, 10 ° C./min-25 ° C./min, 15 ° C./min-30 ° C./min, 20 ° C./min-35 ° C./min, 25 ° C./min-40 ° C./min, or 5 ° C./min-25 ° C./min.

In some embodiments, a holding temperature for vacuum hot pressing and sintering is 100 ° C. to 500 ° C.

In some embodiments, the holding temperature for vacuum hot pressing and sintering is: 100 ° C., 150 ° C., 200 ° C., 250 ° C., 300 ° C., 350 ° C., 400 ° C., 450 ° C., or 500 ° C.

In some embodiments, the holding temperature for vacuum hot pressing and sintering is in a range of: 100 ° C.-200 ° C., 150 ° C.-250 ° C., 200 ° C.-300 ° C., 250 ° C.-350 ° C., 300 ° C.-400 ° C., 350 ° C.-450 ° C., 400 ° C.-500 ° C., 100 ° C.-250 ° C., 150 ° C.-300 ° C., 200 ° C.-350 ° C., 250 ° C.-400 ° C., or 350 ° C.-500 ° C.

In some embodiments, a holding duration for vacuum hot pressing and sintering is 0.5 h to 6 h.

In some embodiments, the holding duration for vacuum hot pressing and sintering is: 0.5 h, 1 h, 1.5 h, 2 h, 2.5 h, 3 h, 3.5 h, 4 h, 4.5 h, 5 h, 5.5 h, or 6 h.

In some embodiments, the holding duration for vacuum hot pressing and sintering is in a range of: 0.5 h-2 h, 1 h-3 h, 1.5 h-4 h, 2 h-5 h, 2.5 h-6 h, 0.5 h-3 h, 1 h-4 h, 1.5 h-5 h, 2 h-6 h, 0.5 h-4 h, 1 h-5 h, or 1.5 h-6 h.

In some embodiments, by configuring the drying as vacuum drying with a temperature of 50 ° C. to 100 ° C. and duration of 3 h to 12 h, the conductive filler/polymer coacervate can be dried thoroughly and rapidly, removing residual solvents. Furthermore, by setting the vacuum hot pressing and sintering conditions as follows: heating at 5 ° C./min to 40 ° C./min under a pressure of 0.5 MPa to 5 MPa from room temperature to 100 ° C. to 500 ° C., and heat preservation for 0.5 h to 6 h, with a vacuum degree less than 100 Pa, the uniformity of the sensor unit 4 across different batches during mass production can be ensured.

S3, attaching the electrodes 2 and the lead wires 3 to the two ends of the sensor unit 4, attaching an upper portion of the sensor unit 4 to the cover layer 1 by vacuum forming, connecting a lower portion of the sensor unit 4 to the composite polymer substrate layer 5 by vacuum hot pressing, and performing cooling to obtain the flexible sensing element 6.

In some embodiments, the two ends of the sensor unit 4 may be connected to the electrodes 3 through various manners such as welding, snap-fit connection, or riveting.

The vacuum forming is a cold processing technique. The vacuum forming is similar to vacuum hot pressing, with the distinction that the vacuum forming does not require heating; instead, the intimate contact between surfaces is achieved through vacuum pressure and interfacial binding forces (e.g., van der Waals forces, hydrogen bonding, or physical interlocking). The vacuum degree and duration for vacuum forming may be determined based on practical requirements.

In S3, the process of connecting the sensor unit 4 to the substrate layer 5 via vacuum hot pressing is similar to the process of obtaining the cover layer 1 via vacuum hot pressing in S1. For detailed steps regarding vacuum hot pressing, please refer to the relevant descriptions provided above.

The cooling is at least one of natural cooling, water cooling, oil cooling, air cooling, forced cooling, and intermittent cooling, and the cooling is performed in an environment with the pressure and the vacuum degree for the vacuum hot pressing and sintering.

The forced cooling is an active cooling manner that drives a cooling medium to rapidly reduce the temperature of an object, achieving quick cooling. The intermittent cooling is a gradient cooling process; by alternately performing cooling and holding steps, the internal heat of the object may be gradually released.

In some embodiments, the specific cooling manner and cooling rate may be determined based on practical requirements.

In some embodiments, the cooling rate is 60 ° C./h.

In some embodiments, the cooling rate is: 50 ° C./h, 52 ° C./h, 54 ° C./h, 56 ° C./h, 58 ° C./h, 60 ° C./h, 62 ° C./h, 64 ° C./h, 66 ° C./h, 68 ° C./h, or 70 ° C./h.

In some embodiments, the cooling rate is in a range of: 50 ° C./h-62 ° C./h, 52 ° C./h-66 ° C./h, 54 ° C./h-68 ° C./h, 56 ° C./h-70 ° C./h, 50 ° C./h-64 ° C./h, 58 ° C./h-70 ° C./h, 52 ° C./h-68 ° C./h, 50 ° C./h-68 ° C./h, 54 ° C./h-66 ° C./h, or 60 ° C./h-68 ° C./h.

In some embodiments, the entire cooling process occurs within the pressure and vacuum degree of the vacuum hot pressing and sintering. By continuously applying pressure, the internal stress generated due to the differences in the coefficients of thermal expansion among the various material layers of the flexible sensing element 6 during the cooling and contraction process can be effectively suppressed. This prevents phenomena such as warping or delamination between the sensor unit 4, the cover layer 1, and the substrate layer 5, ensuring that the multilayer structure of the flexible sensing element 6 remains tightly bonded throughout. Furthermore, the vacuum environment isolates the element from external air and dust, which both prevents the inclusion of impurities like dust within the flexible sensing element 6 and protects the conductive filler (e.g., graphene, metal powder) and electrodes from oxidation, thereby helping to guarantee the product quality of the flexible sensing element 6.

The method for preparing the flexible sensing element 6 provided in the present disclosure employs a vacuum hot pressing formation process, which promotes tight bonding between the polymer and the filler at high temperature under high pressure, greatly improving homogeneity and stability of the polymer and the filler. In addition, the vacuum hot pressing process can further improve mechanical flexibility of the sensing element, optimize an internal conductive channel of the conductive filler and the polymer, and improve a response rate and sensitivity of the sensor unit. Compared with a conventional process, this method has the advantages of simple operation, easy operation, and a high formation yield, which can effectively ensure structural stability and anti-interference of the flexible sensing element 6.

The method for preparing the flexible sensing element 6 provided in some embodiments of the present disclosure is further explained below, using the fabrication of the flexible sensing element 6 as an example.

### Example 1

(1) 0.5 g of polyimide and 0.5 g of surface-treated aramid fibers were mixed and applied on a mold, and dried for 3 h, to obtain a substrate layer 5.

(2) 1 g of thermoplastic polyurethane was weighed and placed on a press block, spacers were placed on two sides of the press block to control a thickness of a cover layer, and the thermoplastic polyurethane was heated and pressed under vacuum to obtain the cover layer 1.

(3) 0.2 g of graphene was weighed and added with 30 mL of tetrahydrofuran solution to a test tube, and the mixture was first stirred mechanically for 30 min and then dispersed ultrasonically for 30 min, to obtain a stable graphene dispersion solution.

(4) 2 g of thermoplastic polyurethane was weighed and added to the graphene dispersion solution, and the mixture was first stirred mechanically for 30 min and then dispersed ultrasonically for 30 min, to obtain a stable graphene/polymer dispersion solution.

(5) 60 mL of methanol solution was added to the graphene/polymer dispersion solution, and the mixture was stirred. The graphene/polymer was separated from the tetrahydrofuran and the methanol, and the tetrahydrofuran and the methanol solution were poured into a waste collection bottle, to obtain a graphene/polymer coacervate. The graphene/polymer coacervate was placed in a vacuum drying oven with a temperature set to 80 ° C. and duration set to 6 h.

(6) The graphene/polymer coacervate was placed in a press block in a vacuum hot pressing and sintering furnace. A 150 mm×150 mm×0.4 mm copper sheet was placed in the middle of the press block, and two 50 mm×10 mm×0.04 mm spacers were placed on two sides of the copper sheet. A pressure was set to 2.2 MPa, a temperature was set to 240 ° C., a heating rate was set to 15 ° C./min, duration for maintaining the temperature was set to 30 min, and the press block was vacuumized to 10 Pa or less. The graphene/polymer coacervate was cooled and demolded to obtain a sensor unit.

(7) Two copper foils were connected to an end portion of the sensor unit 4 to be used as the electrodes 2, and the lead wires 3 were welded to the electrodes 2. The cover layer 1 was placed above the sensor unit 4 and attached to the sensor unit 4 by vacuum forming, then the substrate layer 5 was placed below the sensor unit 4 and connected to the sensor unit 4 by vacuum hot pressing, and then cooled to obtain the flexible sensing element 6.

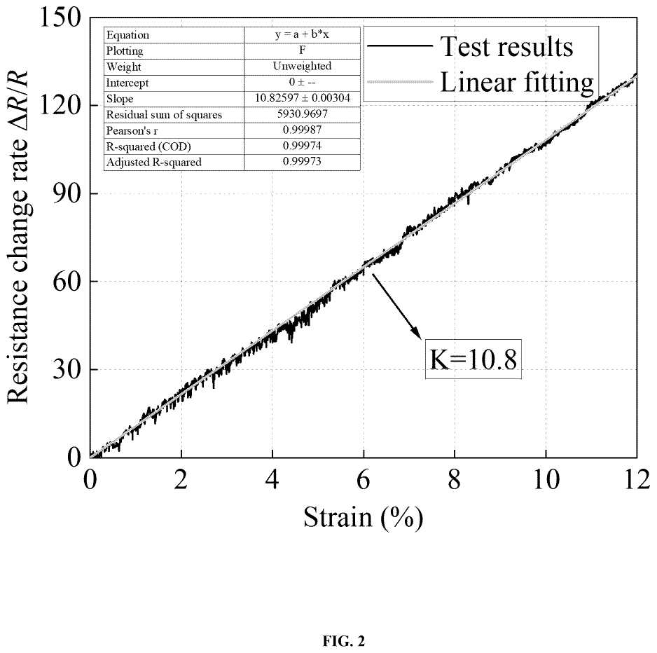

FIG. 2 is a graph of a relationship between a resistance change rate and strain of a flexible sensing element according to Example 1 of the present disclosure. As shown in FIG. 2, a resistance change rate and strain of the flexible sensing element 6 prepared in Example 1 have a good linear relationship. Through calculation, the flexible sensing element 6 has a gauge factor K=10.8, which is significantly higher than a gauge factor (K≈2) of a metal foil strain gauge. Through comparison between test data and linear fitting, goodness of fit R²=0.999, indicating that the test results have good linearity, and an error range of repeated tests for the same group is less than 10%.

### Example 2

The operational procedure of Example 2 is similar to that of Example 1. The differences are only as follows. In step (3), the mass-to-volume ratio of graphene to tetrahydrofuran solution is increased from 0.2 g:30 mL to 0.2 g:60 mL. In step (4), the amount of thermoplastic polyurethane weighed relative to the graphene dispersion solution is increased from 2 g to 4 g. In step (5), the volume of methanol solution added is increased from 60 mL to 120 mL. All other steps and parameters remain the same as in Example 1.

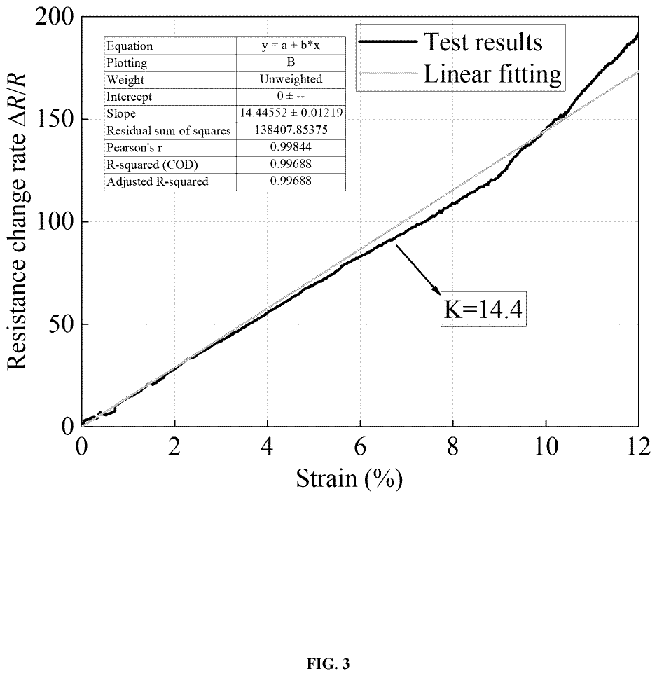

FIG. 3 is a graph of a relationship between a resistance change rate and strain of a flexible sensing element according to Example 2 of the present disclosure. As shown in FIG. 3, a resistance change rate and strain of the flexible sensing element 6 prepared in Example 2 have a good linear relationship. Through calculation, the flexible sensing element 6 has a gauge factor K=14.4, which is significantly higher than a gauge factor (K≈2) of a metal foil strain gauge. Compared with Example 1, the increase in the gauge factor is mainly due to a lower content proportion of graphene, poorer conductivity of the flexible sensing element 6, and a higher resistance change rate. Through comparison between test data and linear fitting, goodness of fit R²=0.996, indicating that the test results have good linearity, and an error range of repeated tests for the same group is less than 10%.

### Example 3

The operational procedure of Example 3 is similar to that of Example 1. The differences are only as follows. In step (3), the mass-to-volume ratio of graphene to tetrahydrofuran solution is increased from 0.2 g: 30 mL to 0.2 g: 90 mL. In step (4), the amount of thermoplastic polyurethane weighed relative to the graphene dispersion solution is increased from 2 g to 6 g. In step (5), the volume of methanol solution added is increased from 60 mL to 180 mL. All other steps and parameters remain the same as in Example 1.

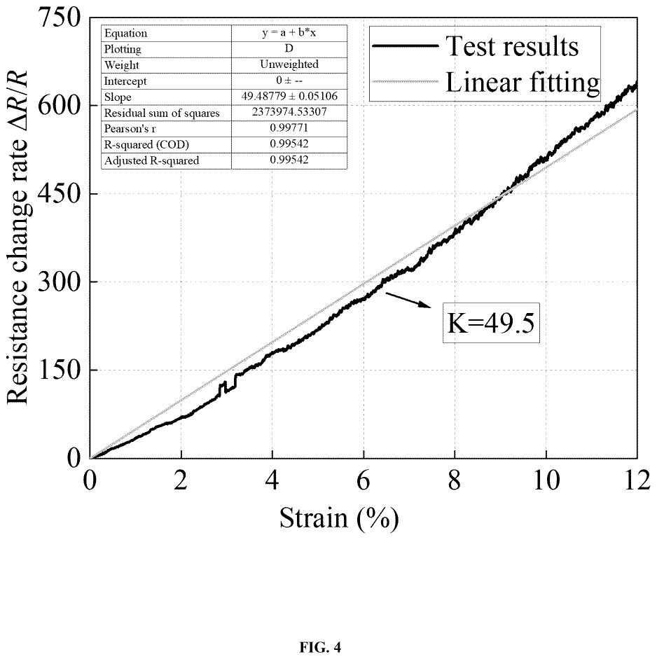

FIG. 4 is a graph of a relationship between a resistance change rate and strain of a flexible sensing element according to Example 3 of the present disclosure. As shown in FIG. 4, a resistance change rate and strain of the flexible sensing element 6 prepared in Example 3 have a good linear relationship. Through calculation, the flexible sensing element 6 has a gauge factor K=49.5, which is significantly higher than a gauge factor (K≈2) of a metal foil strain gauge. Compared with Example 2, the increase in the gauge factor is mainly due to a lower content proportion of graphene, poorer conductivity of the flexible sensing element 6, and a higher resistance change rate. Through comparison between test data and linear fitting, goodness of fit R²=0.995, indicating that the test results have good linearity, and an error range of repeated tests for the same group is less than 10%.

### Example 4

The operational procedure of Example 4 is similar to that of Example 1. The difference is that, in step (6), the thickness of the spacers used is reduced from 0.04 mm to 0.02 mm, resulting in the thickness of the sensor unit 4 being halved. All other steps and parameters remain the same as in Example 1

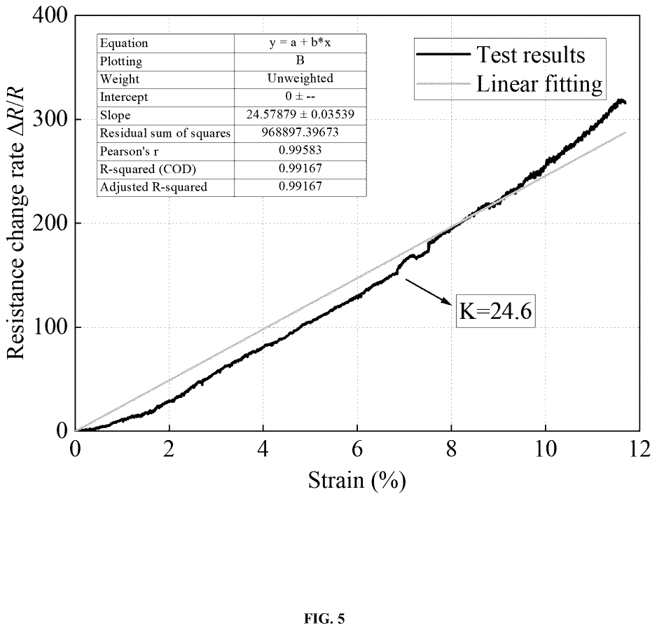

FIG. 5 is a graph of a relationship between a resistance change rate and strain of a flexible sensing element according to Example 4 of the present disclosure. As shown in FIG. 5, in this example, a resistance change rate and strain have a good linear relationship. Through calculation, the flexible sensing element 6 has a gauge factor K=24.6, which is significantly higher than a gauge factor (K≈2) of a metal foil strain gauge. Compared with Example 1, the increase in the gauge factor is mainly because a reduced thickness improves sensitivity of the flexible sensing element 6 to stress distribution on a surface and an interface of the material, thus affecting resistance changes and improving sensitivity. Through comparison between test data and linear fitting, goodness of fit R²=0.992, indicating that the test results have good linearity, and an error range of repeated tests for the same group is less than 10%.

What is claimed is:

1. A flexible sensing element for online monitoring of large strain based on piezoresistive effect, comprising a cover layer, a sensor unit, and a composite polymer substrate layer that are sequentially stacked from top to bottom, wherein:
electrodes are attached to two ends of the sensor unit and are connected to an external signal processing device by lead wires;
the sensor unit is obtained from a conductive filler/polymer coacervate by vacuum hot pressing and sintering, has a thickness of 5 μm to 1000 μm, and comprises the following components in parts by mass: 10 parts to 100 parts of polymer and 1 part to 3 parts of conductive filler;
the cover layer comprises a thermoplastic polymer; and
a method for preparing the flexible sensing element includes:
mixing a polymer base material and a fiber reinforcing phase fully to obtain a mixture, coating the mixture on a mold, and drying the mixture to obtain the composite polymer substrate layer; placing the thermoplastic polymer on a press block, and performing vacuum hot pressing to obtain the cover layer;
mixing the conductive filler and an organic solvent A fully, and adding the polymer, to obtain a conductive filler/polymer dispersion solution, adding an organic solvent B, performing full mixing, and sequentially performing separation, drying, and vacuum hot pressing and sintering, to obtain the sensor unit; and
attaching the electrodes and the lead wires to the two ends of the sensor unit, attaching an upper portion of the sensor unit to the cover layer by vacuum forming, connecting a lower portion of the sensor unit to the composite polymer substrate layer by vacuum hot pressing, and performing cooling.

2. The flexible sensing element according to claim 1, wherein the composite polymer substrate layer comprises the polymer base material and the fiber reinforcing phase in a mass ratio of 1:(0.02-5); the polymer base material is at least one of polyimide or polyester; and the fiber reinforcing phase is at least one of aramid fibers, carbon fibers, carbon nanotubes, and graphene.

3. The flexible sensing element according to claim 2, wherein the fiber reinforcing phase is surface-treated.

4. The flexible sensing element according to claim 1, wherein the polymer is at least one of thermoplastic polyurethane, thermoplastic polyethylene glycol terephthalate, styrene-butadiene-styrene, thermoplastic polyamide, thermoplastic polyolefin, thermoplastic rubber, thermoplastic polyether, styrene-isoprene-styrene, polypropylene, polyvinyl chloride, polycarbonate, and polyethylene; and
the conductive filler is at least one of graphite, graphene, carbon black, carbon nanotubes, copper powder, silver powder, gold powder, aluminum powder, and nickel powder.

5. The flexible sensing element according to claim 4, wherein a count of layers of the graphene is 3 to 200, a sheet diameter distribution is 0.5 μm to 500 μm, and a proportion of a sheet diameter of 0.5 μm to 50 μm is ≥80%; and
the carbon nanotubes are multi-walled carbon nanotubes, with an outer diameter of 1 nm to 100 nm, a length of 1 μm to 50 μm, and a hydroxyl content ≤5 wt %.

6. The flexible sensing element according to claim 1, wherein a thickness of the cover layer and the composite polymer substrate layer is 5 μm to 500 μm ; and porosity of the sensor unit is 0.5% to 30%.

7. The flexible sensing element according to claim 1, wherein a process of the full mixing comprises: mechanical stirring at a rotational speed of 500 r/min to 6000 r/min for 0.1 h to 6 h, and then ultrasonic dispersion for 0.1 h to 6 h; and
a concentration of the conductive filler/polymer dispersion solution is 0.1 mg/mL to 50 mg/mL.

8. The flexible sensing element according to claim 1, wherein the organic solvent A is at least one of tetrahydrofuran, N-methylpyrrolidone, N, N-dimethylformamide, ethyl acetate, butyl ester, acetone, isopropanol, benzene, toluene, xylene, and dichloromethane; and
the organic solvent B is at least one of methanol, ethanol, isopropanol, n-hexane, cyclohexane, n-heptane, ethylene, propylene, chloroform, vinyl chloride, and styrene.

9. The flexible sensing element according to claim 1, wherein the drying is vacuum drying under a following condition: a temperature of 50 ° C. to 100 ° C. and duration of 3 h to 12 h; and
a condition of the vacuum hot pressing and sintering comprises: heating at 5 ° C./min to 40 ° C./min under a pressure of 0.5 MPa to 5 MPa from room temperature to 100 ° C. to 500 ° C., and heat preservation for 0.5 h to 6 h, with a vacuum degree less than 100 Pa.

10. The flexible sensing element according to claim 1, wherein the cooling is at least one of natural cooling, water cooling, oil cooling, air cooling, forced cooling, and intermittent cooling, and the cooling is performed in an environment with a pressure and a vacuum degree for the vacuum hot pressing and sintering, and a cooling rate is controlled at 60 ° C./h.

11. The flexible sensing element according to claim 1, wherein:
each of the electrodes is a copper foil.

12. The flexible sensing element according to claim 1, wherein:
the lead wires are connected to the electrodes by welding.

13. The flexible sensing element according to claim 1, wherein the placing the thermoplastic polymer on a press block, and performing vacuum hot pressing to obtain the cover layer comprises:
placing the thermoplastic polymer on the press block, placing spacers on two sides of the press block to control a thickness of the cover layer, and performing heating and pressing under vacuum to obtain the cover layer.

14. The flexible sensing element according to claim 1, wherein:
the sensor unit adopts a serpentine routing pattern.
